(19) United States
(12) Patent Application Publication
(10) Pub. No.: US 2011/0145058 A1
(43) Pub. Date: Jun. 16, 2011

(54) METHOD AND A SYSTEM FOR KEYWORD VALUATION

(76) Inventors: Yun Liu, Cupertino, CA (US); Christopher Kenneth Orton, Redwood City, CA (US); Ed Woo, Dublin, CA (US)

(21) Appl. No.: 12/638,945

(22) Filed: Dec. 15, 2009

(51) Int. Cl. G06Q 10/00; G06Q 30/00; G06F 17/30; G06Q 50/00

(52) U.S. Cl. 705/14.45; 705/400; 707/748; 707/E17.009

(57) ABSTRACT

A system for keyword valuation is described. An example system includes a communications module, a valuation model selector, and a keyword value calculator. The communications module may be configured to receive a request for a value of a keyword. The valuation model selector may be configured to select a valuation model to be applied for determining the value of the keyword, based on an observed number of clicks associated with the keyword. The keyword value calculator may be configured to calculate the value of the keyword by applying the selected valuation model.

### TECHNICAL FIELD

This application relates to the technical fields of software and/or hardware technology and, in one example embodiment, to a paid search advertisement campaign and a method and system for keyword valuation.

### BACKGROUND

Search engines typically use keywords in order to rank and/or rate a search result to be provided to a user. In automated systems, a ranking algorithm is applied in order to determine the order in which search results associated with one or more keywords are presented on a web page. A search result with a higher ranking may be presented at the top of a list of search results. The ranking may be influenced by compensation provided by a commercial entity to a supplier with respect to the keywords used in the search query.

Search engine providers thus auction off keywords, and then place search results associated with the winning bidder (e.g., an advertisement associated with the keyword(s) provided by the winning bidder) at the top of the search results list. For instance, if a user performs a search for the keyword “telephone,” the advertiser (e.g., a merchant) who is winning the auction for that keyword will have their advertisement displayed on the search results page. When a user clicks on the ad, the advertisement will direct the user to the advertiser's site.

### BRIEF DESCRIPTION OF DRAWINGS

Embodiments of the present invention are illustrated by way of example and not limitation in the FIG.s of the accompanying drawings, in which like reference numbers indicate similar elements and in which:

FIG. 1 is a diagrammatic representation of an architecture within which an example method and system for keyword valuation may be implemented;

FIG. 2 is a diagrammatic representation of an example segmentation associated with a portfolio of keywords;

FIG. 3 is a flow chart illustrating a method for determining the value of a keyword based on the observed number of clicks associated with the keyword, in accordance with an example embodiment;

FIG. 4 is a flow chart illustrating a method for determining the value of a keyword associated with insufficient click history, in accordance with an example embodiment;

FIG. 5 is block diagram of an example keyword valuation system, in accordance with one example embodiment; and

FIG. 6 is a diagrammatic representation of an example machine in the form of a computer system within which a set of instructions for causing the machine to perform any one or more of the methodologies discussed herein may be executed.

### DETAILED DESCRIPTION

Described herein are some embodiments of a method and a system for keyword valuation. In one example embodiment, a system for keyword valuation may be configured to monitor clicks associated with a keyword and, where the observed number of clicks is considered to be less than sufficient to render the calculated actual or observed revenue-per-click value reliable, apply a predictive model for calculation of the value of that keyword. An example predictive model may be generated such that a value calculated for a keyword that has no click history is based on a default value, but depends increasingly on the observed revenue-per-click value for the keyword as the number of observed clicks associated with the keyword approaches a threshold value.

In the following description, numerous details are set forth. It will be apparent, however, to one skilled in the art, that embodiments of the present invention may be practiced without these specific details. In some instances, well-known structures and devices are shown in block diagram form, rather than in detail, in order to avoid obscuring the embodiments present invention.

Some portions of the detailed descriptions below are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments of a system for keyword valuation relate to apparatus for performing the operations herein. This apparatus may be specially constructed for the required purposes, or it may comprise a general-purpose computer selectively activated or reconfigured by a computer program stored in the computer. Such a computer program may be stored in a machine-readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

In some embodiments of a keyword valuation system, the value and rank of a keyword in a portfolio of keywords is determined based on how much revenue, on average, is generated for each click associated with the keyword. The measure of such revenue may be termed a revenue-per-click (RPC) value (or simply RPC) that indicates how much traffic driven to a provider's web site is associated with particular keywords. Each time a user clicks on, for example, an advertisement that contains a keyword, the user's activity on the associated web site is monitored. Based on the monitored activity, an RPC value can be assigned to the keyword. An RPC for a keyword may be used as the foundation for bidding for the keyword in the context of a paid search campaign.

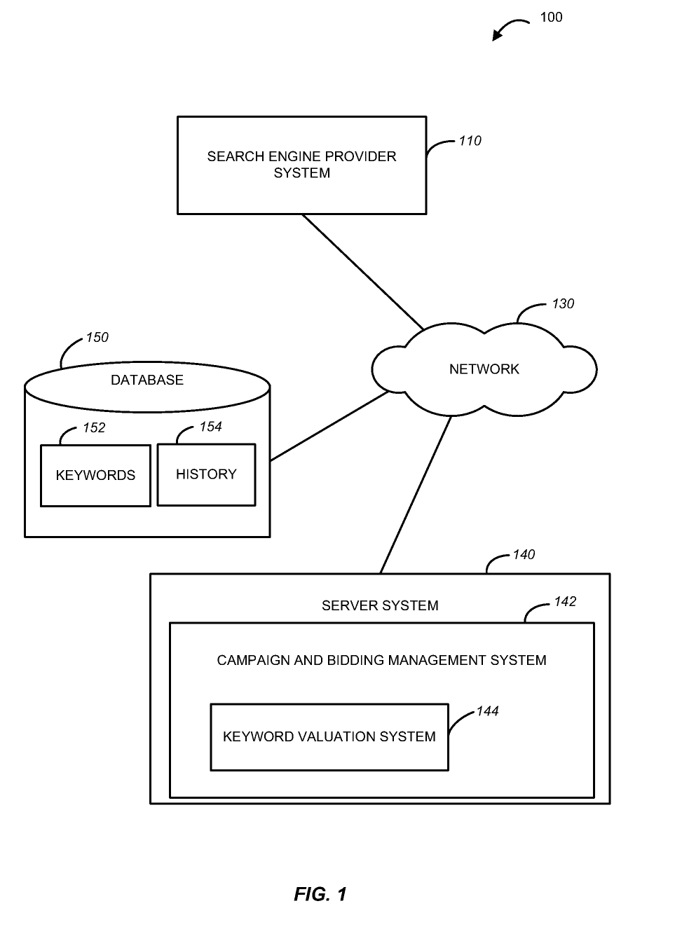

Provided is a machine-learning algorithm that may be used to evaluate how keywords perform in an on-line marketplace, and to use the results of the evaluation to determine respective optimized bids for keywords in a portfolio. When there is no or very little historical data available with respect to a keyword, a keyword valuation system may be configured to assign a default value to the keyword as an estimated value of the keyword (e.g., for bidding purposes), and then adjust the estimated value over time as historical data for the keyword is being collected. In one example embodiment, a keyword valuation system may be configured to weight current user activities (e.g., user's activities that occurred recently) more heavily than activities that occurred further in the past, when determining a value for a keyword. An example system for keyword valuation may be implemented in the context of a network environment as shown in FIG. 1.

FIG. 1 is a diagrammatic representation of an architecture 100 within which an example system for keyword valuation may be implemented. As shown in FIG. 1, a keyword valuation system 144 may be provided with a campaign and bidding management system 142, which, in turn, may be hosted by a server system 140. The campaign and bidding management system 142 may be configured to communicate with a search engine provider system 110 via a communications network 130. The communications network 130 may be a public network (e.g., the Internet, a wireless network, etc.) or a private network (e.g., a local area network (LAN), a wide area network (WAN), Intranet, etc.).

In one example embodiment, the campaign and bidding management system 142 may be configured to maintain a portfolio of keywords that have been identified as potentially useful in search queries. As search engine providers auction off keywords for placing results or advertisements associated with the winning bidder at the top of the list of results, the campaign and bidding management system 142 may be utilized to submit keyword bids to the search engine provider system 110. The campaign and bidding management system 142 may utilize the keyword valuation system 144 to obtain estimated keyword values and generate respective bids. The keyword valuation system 144 may be configured to collect keywords and to monitor events reflecting user activities associated with respective keywords. The keyword valuation system 144 may also assemble the collected events associated with various keywords into respective keyword histories. The keywords and associated histories may be stored in a database 150, e.g., as keywords 152 and history 154. The keyword valuation system 144 may use historical information associated with a keyword (e.g., the number and frequency of clicks associated with the keyword, revenue generated as a result of those clicks, etc.) to calculate the value of the keyword that may then be used by the campaign and bidding management system 142 for a bid for a keyword with the search engine provider system 110.

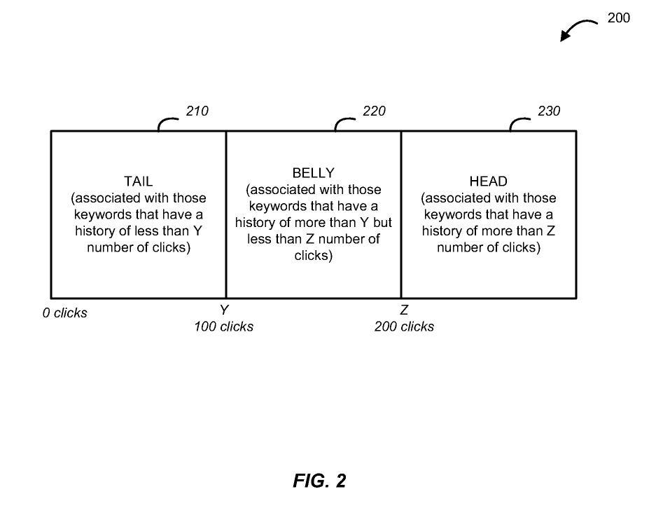

As mentioned above, when a history of clicks and revenue for a keyword is not available or is insufficient, the keyword valuation system 144 may utilize a predetermined default value as a predicted value for the keyword. In one example embodiment, the keyword valuation system 144 may group keywords according to the detected number of clicks associated with respective keywords (thus creating a segmentation of keywords) and applying different valuation models based on the location of a keyword in the segmentation. An example segmentation of keywords (also referred as simply “segmentation”) may be described with reference to FIG. 2

FIG. 2 is a diagrammatic representation of an example segmentation 200 associated with a portfolio of keywords. As shown in FIG. 2, the segmentation 200 comprises three buckets—TAIL 210, BELLY 220, and HEAD 230. Keywords that are associated with fewer than a certain number of clicks (e.g., a first threshold value “Y” that may be set, e.g., at 100 clicks) are associated with (or placed into) the TAIL 210. Keywords that are associated with greater than a certain number of clicks (e.g., a second threshold value “Z” that may be set, e.g., at 200 clicks) are associated with (or placed into) the HEAD 230. Keywords that are associated with the number of clicks that is anywhere between the first threshold value “Y” and the second threshold value “Z” are associated with (or placed into) the BELLY 220.

In one example embodiment, the placement of a keyword into a certain bucket in the segmentation 200 determines which valuation model is to be applied when calculating the value of a keyword. When a keyword is placed in the HEAD 230 bucket of the segmentation 200, it may be inferred that there is sufficient historical information available to use a regression approach for calculating the value for the keyword. For example, if historical conversion rate (X1) and time on site (X2) have equal power predicting future value, then the future value of a keyword may be calculated as 0.5*X1+0.5*X2. When a keyword is placed in the TAIL 210 bucket of the segmentation 200, it may be inferred that there is no or insufficient historical information available. The keyword valuation system 144 of FIG. 1 applies a predictive valuation model to keywords placed in the TAIL 210 bucket of the segmentation 200.

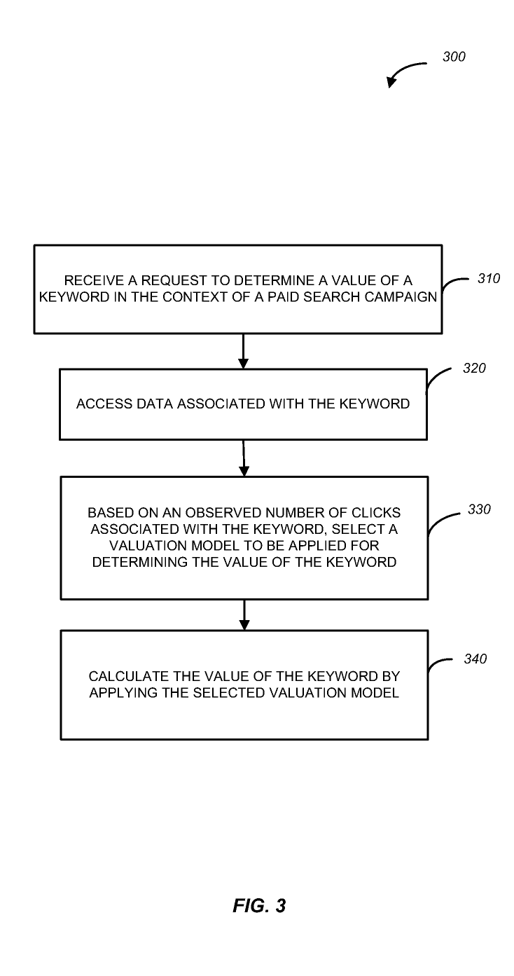

As mentioned above, the keyword valuation system 144 may utilize a predictive model that relies increasingly on historical information (e.g., the observed RPC associated with the keyword) as the number of clicks associated with the keyword approaches the first threshold value. The keyword valuation system 144 of FIG. 1 may be configured to apply a combination of the regression approach and a predictive valuation model to keywords placed in the BELLY 220 bucket of the segmentation 200. One example implementation is to replace the default revenue_per_click with the regression results for BELLY keywords. An example of using segmentation 200 for determining which valuation model is to be applied to calculating the value of a keyword may be described with reference to FIG. 3.

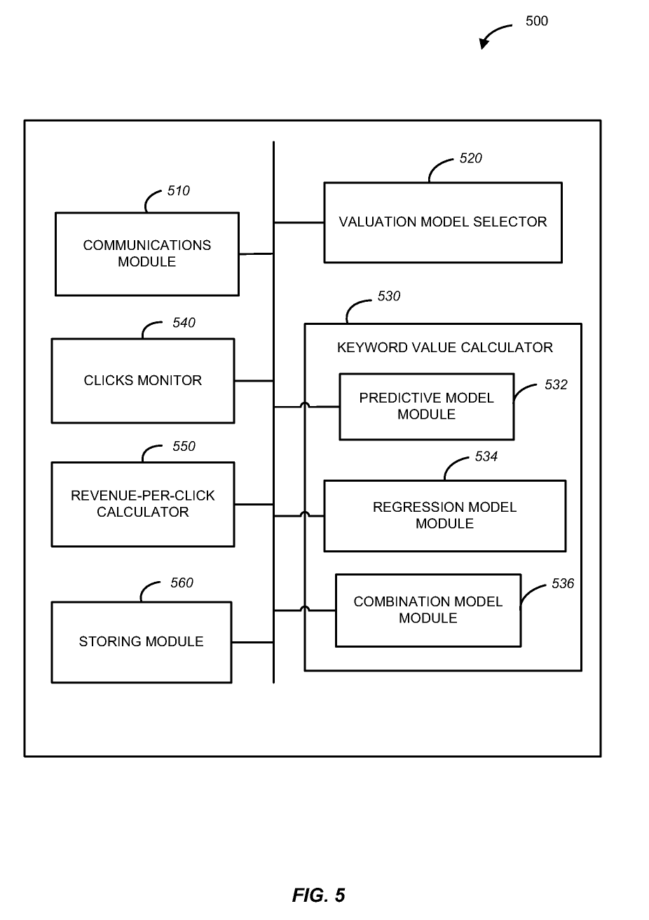

FIG. 3 is a flow chart illustrating a method 300 for determining the value of a keyword based on the observed number of clicks associated with the keyword, in accordance with an example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at a server system 140 of FIG. 1. In one example embodiment, the method 300 may be performed by the various modules discussed further below with reference to FIG. 5. Each of these modules may comprise processing logic.

As shown in FIG. 3, the method commences at operation 310 where a communications module of an example keyword valuation system receives a request to determine a value of a keyword. The request may originate in the context of a paid search campaign. At operation 320, a valuation model selector of the keyword valuation system accesses data associated with the keyword and, based on the observed number of clicks associated with the keyword, selects a valuation model to be applied for determining the value of the keyword, at operation 330. A keyword valuation system may include a clicks monitor to monitor clicks associated with keywords and to store the number of observed clicks, e.g., as part of the historical information associated with respective keywords in the database 150 of FIG. 1.

As described above with reference to FIG. 2, the number of clicks observed with respect to a keyword may determine the position of the keyword within a segmentation. A valuation model selector may be configured to select a valuation model for determining the value of a keyword based on the position of the keyword in the segmentation. At operation 340, a keyword value calculator of the keyword valuation system calculates the value of the keyword by applying the selected valuation model.

When a keyword has no or very little historical information associated with it, e.g., when the number of observed clicks associated with a keyword is below a predetermined threshold value, the valuation model selector applies a predictive model described above with reference to FIG. 2.

As mentioned above, the value of a keyword may be expressed as a revenue-per-click value. In one embodiment, the predictive model can be expressed as provided below.

eRPC=dRPC*c/y+aRPC*(1−c/y)

In the expression shown above, eRPC is an estimated revenue-per-click associated with the keyword (which may also be used as the value of the keyword), aRPC is the observed revenue-per-click associated with the keyword, dRPC is a default revenue-per-click, c is the observed number of clicks associated with the keyword and y is the threshold value.

In some embodiments, other variations of a linear decay formula may be applied to calculate an estimated revenue-per-click associated with a keyword. One example variant is shown below.

eRPC=dRPC*(c/y)²+aRPC*(1−(c/y)²)

In the expression shown above, eRPC is an estimated revenue-per-click associated with the keyword, aRPC is the observed revenue-per-click associated with the keyword, dRPC is a default revenue-per-click, c is the observed number of clicks associated with the keyword and y is the threshold value. Y is always greater than zero. C is capped by y so that the value of c/y is always greater than or equal to one.

A generalized expression of the predictive model is shown below.

eRPC=dRPC*f(c,y)+aRPC*(1−f(c,y))

In the expression shown above, eRPC is an estimated revenue-per-click associated with the keyword, aRPC is the observed revenue-per-click associated with the keyword, dRPC is a default revenue-per-click, c is the observed number of clicks associated with the keyword and y is the threshold value.

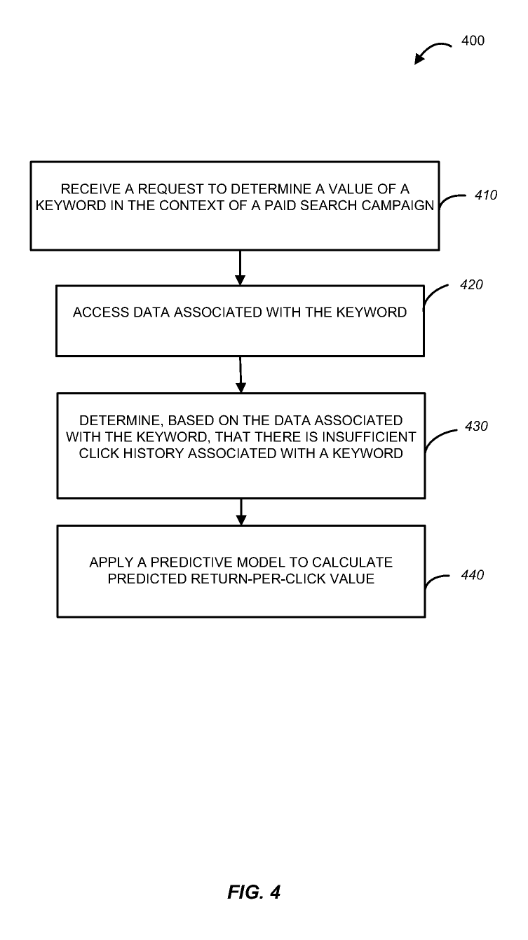

FIG. 4 is a flow chart illustrating a method 400 for determining the value of a keyword associated with an insufficient click history, in accordance with an example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at a server system 140 of FIG. 1. In one example embodiment, the method 400 may be performed by the various modules discussed further below with reference to FIG. 5. Each of these modules may comprise processing logic.

As shown in FIG. 4, the method commences at operation 410 where a communications module of an example keyword valuation system receives a request to determine a value of a keyword. As mentioned above with reference to FIG. 3, the request may originate in the context of a paid search campaign. At operation 420, a valuation model selector of the keyword valuation system accesses data associated with the keyword and, based on the accessed data associated with the keyword, determines (at operation 430) that the click history (e.g., the number of observed clicks) associated with the keyword is below a threshold value and thus warrants the application of the predictive valuation model described above. At operation 440, a keyword value calculator of the keyword valuation system calculates the value of the keyword by applying the predictive valuation model. The calculated value of the keyword may be stored for future use, e.g., for generating a bid on the keyword to be submitted to one or more search engine providers.

FIG. 5 is block diagram of an example keyword valuation system 500, in accordance with one example embodiment. The keyword valuation system 500 comprises a communications module 510, a valuation model selector 520, and a keyword value calculator 530. The communications module 510 may be configured to receive a request for a value of a keyword. The valuation model selector 520 may be configured to select a valuation model to be applied for determining the value of the keyword, e.g., based on an observed number of clicks associated with the keyword or based on the position of the keyword in a segmentation, as described with reference to FIG. 2. The keyword value calculator 530 may be configured to calculate the value of the keyword by applying the selected valuation model. The keyword value calculator 530 may include a predictive model module 532 to apply a predictive model that relies increasingly on historical information associated with the keyword as the number of clicks associated with the keyword approaches the threshold value. A regression model module 534, also included in the keyword value calculator 530, may be configured to calculate the value of a keyword by applying regression techniques. A combination model module 536 may be configured to apply a combination of the predictive model and the regression model.

The keyword valuation system 500 may also include a clicks monitor 540 to monitor clicks associated with the keyword and store the monitored clicks as the observed number of clicks associated with the keyword, a revenue-per-click calculator 550 to calculate the observed revenue-per-click for keywords, and a storing module 560 to store respective calculated values of keywords for use, e.g., in the context of a paid search campaign. The revenue-per-click calculator 550 may calculate revenue-per-click for a keyword by determining total revenue associated with the keyword and dividing the total revenue associated with the keyword by the observed number of clicks associated with the keyword. The revenue-per-click calculator 550 may also utilize data related to observed activities of uses associated with the keyword in calculating revenue-per-click for a keyword. Still further, revenue-per-click calculator 550 may be configured to weight a user's activities associated with the keyword according to respective time frames of the user's activities, e.g., assigning greater weight to more recent activities than to activities that occurred further in the past.

It will be noted that, in some example embodiments, the functions performed by two separate modules of the system 500 may be performed by a single module. Conversely, the operations performed by more than one module shown in FIG. 5 may be performed by a single module.

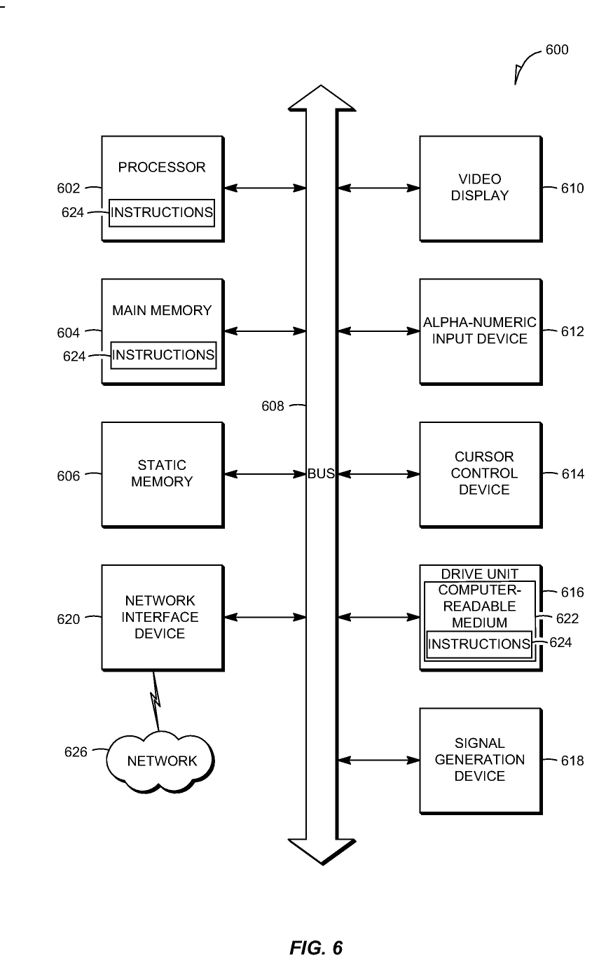

FIG. 6 shows a diagrammatic representation of a machine in the example form of a computer system 600 within which a set of instructions for causing the machine to perform any one or more of the methodologies discussed herein may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alpha-numeric input device 612 (e.g., a keyboard), a user interface (UI) navigation device 614 (e.g., a cursor control device), a disk drive unit 616, a signal generation device 618 (e.g., a speaker) and a network interface device 620.

The disk drive unit 616 includes a computer-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, with the main memory 604 and the processor 602 also constituting machine-readable media.

The instructions 624 may further be transmitted or received over a network 626 via the network interface device 620 utilizing any one of a number of well-known transfer protocols (e.g., Hyper Text Transfer Protocol (HTTP)).

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that causes the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories and optical and magnetic media. Such media may also include, without limitation, hard disks, floppy disks, flash memory cards, digital video disks, random access memory (RAM), read-only memory (ROM), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

Thus, a system for keyword valuation has been described. Although the system has been described with reference to specific example embodiments, it will be evident that various modifications and changes may be made to these embodiments without departing from the broader spirit and scope of the inventive subject matter. Thus, any type of server and client environment, based on an architecture-neutral-language, including various system architectures, may employ various embodiments described herein. Accordingly, the specification and drawings are to be regarded in an illustrative rather than a restrictive sense.

What is claimed is:

1. A computer-implemented system comprising:
a communications module to receive a request for a value of a keyword;
a valuation model selector to select a valuation model to be applied for determining the value of the keyword, based on an observed number of clicks associated with the keyword; and
a keyword value calculator to calculate the value of the keyword by applying the selected valuation model.

2. The system of claim 1, comprising a storing module to store the calculated value of the keyword in a portfolio of keywords for use in a context of a paid search campaign.

3. The system of claim 1, comprising a clicks monitor to:
monitor clicks associated with the keyword; and
store the monitored clicks as the observed number of clicks associated with the keyword.

4. The system of claim 1, wherein:
the observed number of clicks is less than a first threshold value; and
the selected valuation model is a predictive model that relies increasingly on observed revenue-per-click associated with the keyword as the observed number of clicks associated with the keyword approaches a threshold value.

5. The system of claim 4, comprising a revenue-per-click calculator to calculate the observed revenue-per-click by:
determining total revenue associated with the keyword; and
dividing the total revenue associated with the keyword by the observed number of clicks associated with the keyword.

6. The system of claim 4, wherein the predictive model is expressed as
eRPC=dRPC*c/y+aRPC*(1−c/y),
wherein eRPC is an estimated revenue-per-click associated with the keyword, aRPC is the observed revenue-per-click, dRPC is a default revenue-per-click, c is the observed number of clicks associated with the keyword and y is the threshold value.

7. The system of claim 6, comprising a revenue-per-click calculator is to calculate the observed revenue-per-click based on users' activities associated with the keyword.

8. The system of claim 7, wherein the revenue-per-click calculator is to weight an event from user's activities associated with the keyword based on a time associated with the event occurrence.

9. A computer-implemented method comprising:
using one or more processors to perform operations of:
receiving a request to determine a value of a keyword in the context of a paid search campaign;
determining that the keyword is associated with a number of clicks below a threshold value; and
calculating the value of the keyword by applying a predictive model that relies increasingly on historical information associated with the keyword as the number of clicks associated with the keyword approaches the threshold value.

10. The method of claim 9, wherein the historical information associated with the keyword is a revenue-per-click calculated by dividing total revenue associated with the keyword by the number of clicks associated with the keyword.

11. A computer-implemented method comprising:
using one or more processors to perform operations of:
receiving a request for a value of a keyword;
based on an observed number of clicks associated with the keyword, selecting a valuation model to be applied for determining the value of the keyword; and
calculating the value of the keyword by applying the selected valuation model.

12. The method of claim 11, further comprising storing the calculated keyword value for use with a paid search campaign.

13. The method of claim 11, comprising:
monitoring clicks associated with the keyword; and
storing the monitored clicks as the observed number of clicks associated with the keyword.

14. The method of claim 11 wherein:
the observed number of clicks is less than a first threshold value; and
the selected valuation model is a predictive model that relies increasingly on observed revenue-per-click associated with the keyword as the observed number of clicks associated with the keyword approaches a threshold value.

15. The method of claim 14, wherein the observed revenue-per-click is calculated by dividing total revenue associated with the keyword by the observed number of clicks associated with the keyword.

16. The method of claim 14, wherein the predictive model is expressed as
eRPC=dRPC*c/y+aRPC*(1−c/y),
wherein eRPC is an estimated revenue-per-click associated with the keyword, aRPC is the observed revenue-per-click, dRPC is a default revenue-per-click, c is the observed number of clicks associated with the keyword and y is the threshold value.

17. The method of claim 16, comprising a revenue-per-click calculator is to calculate the observed revenue-per-click based on users' activities associated with the keyword.

18. The method of claim 17, wherein the revenue-per-click calculator is to weight an event from user's activities associated with the keyword based on a time associated with the event occurrence.

19. A machine-readable medium having instruction data to cause a machine to:
receive a request for a value of a keyword;
based on an observed number of clicks associated with the keyword, select a valuation model to be applied for determining the value of the keyword; and
calculate the value of the keyword by applying the selected valuation model.

20. The machine-readable medium of claim 19, wherein the selected valuation model is a predictive model that relies increasingly on historical information associated with the keyword as a number of clicks associated with the keyword approaches a threshold value.
